(19) United States
(12) Patent Application Publication
(10) Pub. No.: US 2022/0366388 A1
(43) Pub. Date: Nov. 17, 2022

(54) METHOD AND COMPUTER PROGRAM PRODUCT FOR MATCHING AND DISPLAYING PAYMENT REFERENCE DATA AND PURCHASED PRODUCT INFORMATION

(71) Applicant: SOFTLUNCH INC., Seoul (KR)

(72) Inventors: Jinheung BAE, Seoul (KR); Sangwoo JEON, Seongnam-si, Gyeonggi-do (KR)

(21) Appl. No.: 17/633,888

(22) PCT Filed: Nov. 30, 2020
(86) PCT No.: PCT/KR2020/017271

§ 371 Date: Feb. 8, 2022

(30) Foreign Application Priority Data
Nov. 10, 2020 (KR) 10-2020-0149661

(51) Int. Cl. G06Q 20/12; G06Q 30/02; G06Q 30/06

(52) U.S. Cl. CPC G06Q 20/12; G06Q 30/0283; G06Q 30/0641

(57) ABSTRACT

This application relates to a method of matching and displaying payment reference data and purchased product information. In one aspect, the method includes obtaining payment reference data received by a user terminal, and accessing a shopping mall server in response to the obtaining of the payment reference data. The method may also include obtaining purchased product information matching the payment reference data from the shopping mall server, matching the payment reference data and the purchased product information, and displaying a result of the matching.

### TECHNICAL FIELD

The present disclosure provides a method and computer program product for matching and displaying payment reference data and purchased product information.

### BACKGROUND ART

With the development of various services for analyzing and managing consumption of a user, a technology capable of accurately obtaining payment information of the user in real time is required.

Accordingly, in the prior art, when the user performs payment at an affiliated store, payment data of the user is generated and managed depending on affiliated store information registered in a card company. However, there is a limitation in that the payment data needs to be manually corrected and generated by the user when it is unable to obtain accurate affiliated store information, such as when the affiliate store is not changed or when payment is made using cash.

Also, in the prior art, when the user performs online payment, payment reference data is obtained from a payment reference data providing server, such as an open market or a web page, but the payment reference data does not include detailed information about a purchased product, and thus it is difficult for the user to determine which purchased product matches the payment reference data only with the payment reference data.

### DESCRIPTION OF EMBODIMENTS

### Technical Problem

The present disclosure provides a method and computer program product for matching and displaying payment reference data and purchased product information. Technical problems to be achieved by the current embodiment are not limited to those described above, and other technical problems may be inferred from following embodiments.

### Solution to Problem

As a technical means for achieving the technical problem described above, a first aspect of the present disclosure may provide a method of matching and displaying payment reference data and purchased product information, including: obtaining payment reference data received by a user terminal; accessing a shopping mall server in response to the obtaining of the payment reference data; obtaining purchased product information matching the payment reference data from the shopping mall server; and matching the payment reference data and the purchased product information, and displaying a result of the matching.

A second aspect of the present disclosure may provide a computer program product including one or more computer-readable recording media storing a program for: obtaining payment reference data received by a user terminal; accessing a shopping mall server in response to the obtaining of the payment reference data; obtaining purchased product information matching the payment reference data from the shopping mall server; and matching the payment reference data with the purchased product information, and displaying a result of the matching.

### Advantageous Effects of Disclosure

According to the above-described solution to problem of the present disclosure, by providing a user with purchased product information matching payment reference data together with content included in the payment reference data, it is possible to help the user to understand the payment reference data.

### BRIEF DESCRIPTION OF DRAWINGS

FIG. 1 is a system diagram including a user terminal, a payment reference data providing server, and an online shopping mall server, according to an embodiment.

FIG. 2 is a diagram for describing an example of obtaining payment reference data by a user terminal after payment is performed in an online shopping mall, according to an embodiment.

FIG. 3 is a diagram for describing an example of recording payment reference data in an application, according to an embodiment.

FIG. 4 is a diagram for describing an example of payment reference data, according to an embodiment.

FIG. 5 is a diagram for describing an example of accessing a shopping mall server from an application, according to an embodiment.

FIG. 6 is a diagram for describing an example of matching payment reference data and a purchased product, according to an embodiment.

FIG. 7 is a diagram for describing an example of matching and displaying payment reference data and purchased product information, according to an embodiment.

FIG. 8 is an exemplary diagram for describing a method of correcting price information regarding a purchased product, according to an embodiment.

FIG. 9 is a flowchart of a method of matching and displaying payment reference data and purchased product information, according to an embodiment.

FIG. 10 is a block diagram of an application operation server according to an embodiment.

### MODE OF DISCLOSURE

Hereinafter, embodiments of the present disclosure will be described in detail with reference to the accompanying drawings such that one of ordinary skill in the art may easily implement the present disclosure. However, the present disclosure may be implemented in various different forms and is not limited to embodiments described herein. Also, in the drawings, parts irrelevant to the description are omitted in order to clearly describe the present disclosure, and like reference numerals designate like elements throughout the specification.

Throughout the specification, when a part is “connected” to another part, the part may not only be “directly connected” to the other part, but may also be “electrically connected” to the other part with another element in between. In addition, when a part “includes” a certain element, the part may further include another element instead of excluding the other element, unless otherwise stated.

Hereinafter, the present disclosure will be described in detail with reference to the accompanying drawings.

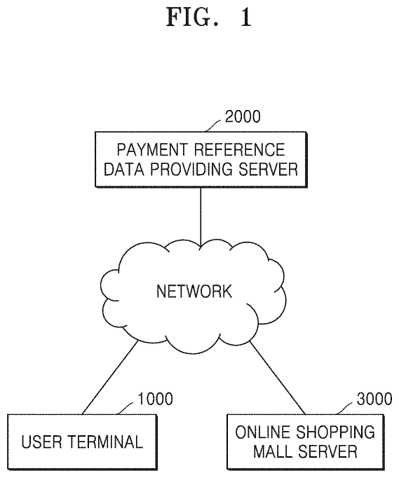

FIG. 1 is a system diagram including a user terminal, a payment reference data providing server, and an online shopping mall server, according to an embodiment.

A system according to an embodiment may include a user terminal 1000, a payment reference data providing server 2000, and an online shopping mall server 3000.

The user terminal 1000 may be a smartphone, a tablet personal computer (PC), a PC, a smart television (TV), a mobile phone, a personal digital assistant (PDA), a laptop computer, a media player, a micro server, a global positioning system (GPS) device, an electronic book terminal, a digital broadcasting terminal, a navigation device, a kiosk, an MP3 player, a digital camera, a home appliance, a device on which a camera is mounted, or another mobile or non-mobile computing device. Also, the user terminal 1000 may be a wearable device, such as a watch, glasses, a hair band, or a ring, having a communication function and a data processing function. However, the user terminal 1000 is not limited thereto.

The payment reference data providing server 2000 may refer to any type of server that manages a web and/or an app capable of providing payment reference data. For example, the payment reference data providing server 2000 may include a bank server, a card company server, a payment gateway (PG) company server, a value added network (VAN) company server, or the like. In addition, the payment reference data providing server 2000 may include a server of a company that collects, by proxy, payment reference data from a bank server or a card company server.

The online shopping mall server 3000 is a server that operates an online shopping mall. The online shopping mall may include any type of platform capable of selling products online, such as an open market, a social commerce, a general mall, or an individual shopping mall.

The online shopping mall server 3000 may communicate with the user terminal 1000 and the payment reference data providing server 2000 through a network. The online shopping mall server 3000 may transmit purchased product information to the user terminal 1000 through an application installed in the user terminal 1000. The purchased product information may include shopping mall information, a product name, the quantity, manufacturer information, and the like. Also, the online shopping mall server 3000 may transmit payment-related information to the payment reference data providing server 2000. The payment-related information may include at least one of price information, time information, and a payment method (for example, card payment, cash payment, or account transfer) related information regarding a purchased product.

The payment reference data providing server 2000 may communicate with the user terminal 1000 through the network.

According to an embodiment, the payment reference data providing server 2000 may transmit a trigger signal to the user terminal 1000. The trigger signal may include, but is not limited to, a text message, a push notification through an application installed in the user terminal 1000, an e-mail, or the like. The trigger signal may include the payment reference data.

According to another embodiment, the user terminal 1000 or a server operating an application installed in the user terminal 1000 may receive the payment reference data from the payment reference data providing server 2000. For example, the user terminal 1000 may access a card company server that is the payment reference data providing server 2000 to collect the payment reference data or receive the payment reference data from the card company server.

The payment reference data may include the payment-related information and payment reference data providing server information. The payment-related information may include at least one of price information, time information, and a payment method (for example, card payment, cash payment, or account transfer) related information regarding a purchased product. The payment reference data providing server information is information about a server that provides the payment reference data, and may include at least one of affiliated store information and PG company information. Meanwhile, data included in the payment reference data is not limited to the above examples, and the payment reference data may include, without limitation, any data as long as the data is included in the trigger signal or the data is receivable from the payment reference data providing server 2000.

Servers referred to as the payment reference data providing server 2000 and the online shopping mall server 3000 may be implemented as a computer device or a plurality of computer devices that communicate through a network to provide commands, codes, files, contents, services, and the like.

The user terminal 1000, the payment reference data providing server 2000, and the online shopping mall server 3000 may perform communication using the network. For example, the network includes a local area network (LAN), a wide area network (WAN), a value added network (VAN), a mobile radio communication network, a satellite communication network, or a mutual combination thereof, is a data communication network having a comprehensive meaning enabling network components shown in FIG. 1 to smoothly communicate with each other, and may include the wired Internet, the wireless Internet, or a mobile wireless communication network. In addition, wireless communication may be, for example, wireless LAN (Wi-Fi), Bluetooth, Bluetooth low energy, ZigBee, Wi-Fi direct (WFD), ultra wideband (UWB), infrared data association (IrDA), near field communication (NFC), or the like, but is not limited thereto.

Meanwhile, when only the payment reference data is transmitted from the payment reference data providing server 2000 to the user terminal 1000, the payment reference data includes only the payment-related information and the payment reference data providing server information, and does not include the purchased product information, and thus it may be difficult for a user using the user terminal 1000 to match and identify the payment reference data and a purchased product.

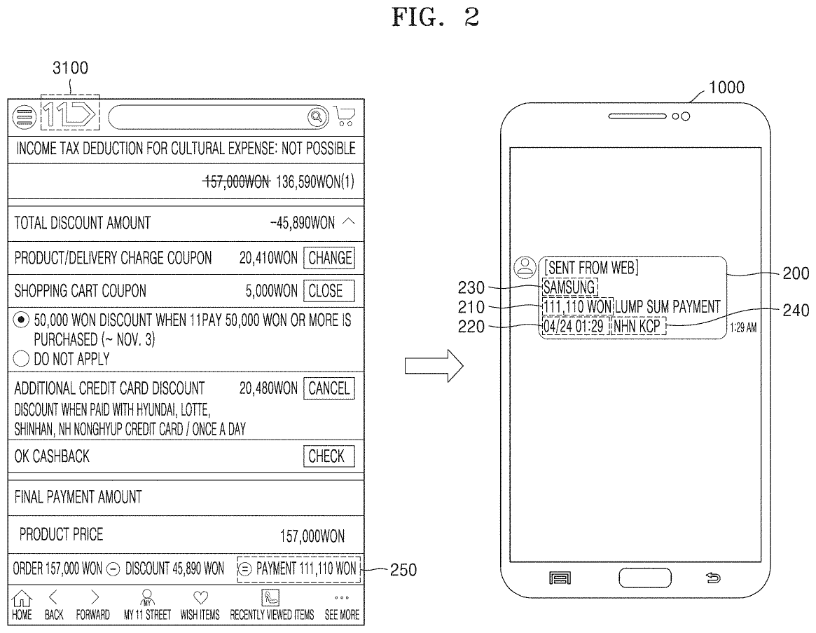

FIG. 2 is a diagram for describing an example of obtaining payment reference data by a user terminal after payment is performed in an online shopping mall, according to an embodiment.

Referring to FIG. 2, the user may access an online shopping mall website 3100 operated by the online shopping mall server 3000, by using the user terminal 1000. When the user selects a product to be purchase from the online shopping mall website 3100, the online shopping mall website 3100 may provide a screen for payment. The user may identify a final price 250 for a purchased product and proceed with payment.

When the payment is made, the online shopping mall server 3000 operating the online shopping mall website 3100 may transmit payment-related information to the payment reference data providing server 2000. The payment-related information may include at least one of price information, time information, and a payment method (for example, card payment, cash payment, or account transfer) related information regarding the purchased product.

The payment reference data providing server 2000 may receive the payment-related information from the online shopping mall server 3000 and proceed with a payment process. A plurality of the payment reference data providing servers 2000 may be involved in the payment process.

After the payment process is completed, the payment reference data providing server 2000 may transmit a trigger signal to the user terminal 1000. The trigger signal may be a text message, a push notification, an email, or the like.

The trigger signal may include payment reference data 200. The payment reference data 200 may include payment-related information and payment reference data providing server information 240. The payment-related information may include price information 210 regarding the purchased product, time information 220 about when payment for the purchased product is completed, and payment method related information 230. The payment reference data providing server information 240 may include information about a company operating a server for providing payment reference data.

Referring to the payment reference data 200 of FIG. 2, it is verified that the user has paid 111,110 won in a lump sum by using Samsung Card at 01:29 on April 24, and a payment reference data providing server is operated by a PG company “NHN KCP”.

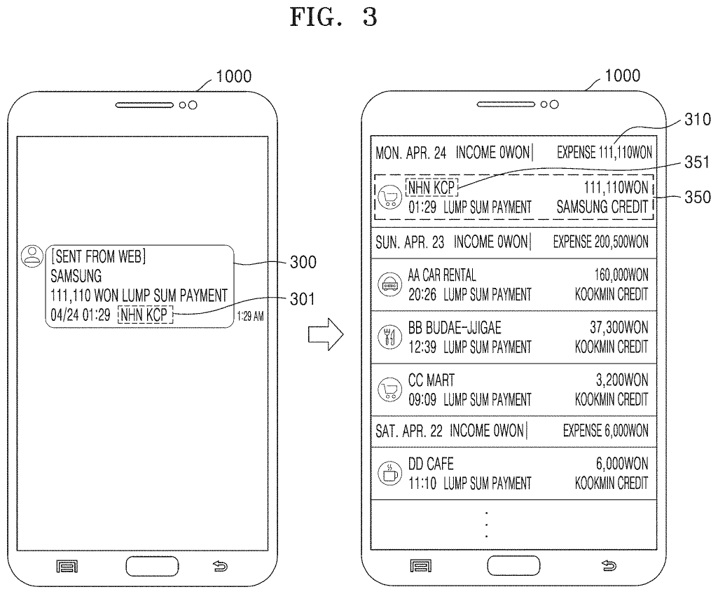

FIG. 3 is a diagram for describing an example of recording payment reference data in an application, according to an embodiment.

Referring to FIG. 3, the user terminal 1000 may receive payment reference data 300 from the payment reference data providing server 2000. As described above with reference to FIG. 2, the payment reference data 300 may further include payment reference data providing server information 301 in addition to payment-related information.

An application 310 for providing purchase details and payment details may be installed in the user terminal 1000. In response to receiving a trigger signal including the payment reference data 300 from the user terminal 1000, the application 310 may record content included in the payment reference data 300. The user may identify purchase details and payment details through the application 310.

Payment details 350 corresponding to the payment reference data 300 may be recorded in the application 310. The payment details 350 are recorded based on the payment reference data 300, and thus when the payment reference data 300 includes the payment-related information and the payment reference data providing server information 301, payment-related information and payment reference data providing server information 351 are also recorded in the payment details 350 of the application 310.

According to an embodiment, the application 310 may record the content of payment reference data 300 whenever a trigger signal (for example, a text message, a push notification, an e-mail, or the like) including the payment reference data 300 is received.

According to another embodiment, the application 310 may set a predetermined time regardless of whether the trigger signal is received, and comprehensively record the content of the payment reference data 300 included in all trigger signals received for the predetermined time. For example, the application 310 may set 3 hours as the predetermined time, and record the content of the payment reference data 300 received for 3 hours at intervals of 3 hours.

According to another embodiment, the application 310 may, in response to receiving an input of the user, regardless of whether the trigger signal is received, comprehensively record the content of payment reference data 300 included in all trigger signals received during a period of time between a previous user input and a current user input.

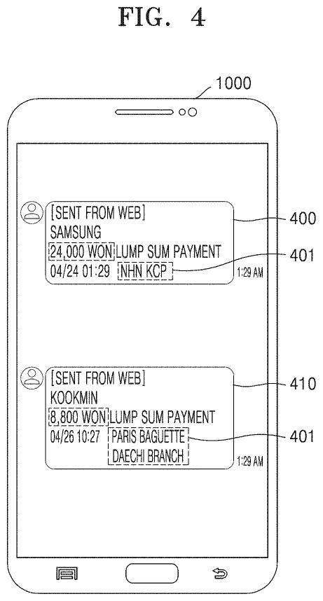

FIG. 4 is a diagram for describing an example of payment reference data, according to an embodiment.

Referring to FIG. 4, the user terminal 1000 may receive pieces of payment reference data 400 and 410 from the payment reference data providing server 2000.

When the user purchases a product from an online shopping mall, the user terminal 1000 may receive first payment reference data 400 from the payment reference data providing server 2000. When a user purchases a product from an offline store, the user terminal 1000 may receive second payment reference data 410 from the payment reference data providing server 2000.

When the user purchases a product from the online shopping mall, the online shopping mall server 3000 may transmit payment-related information to the payment reference data providing server 2000. The payment reference data providing server 2000 may transmit, to the user terminal 1000, payment reference data providing server information 401 together with the payment-related information. Payment is generally made through a PG company when the online shopping mall is used, and thus the payment reference data providing server 2000 becomes a PG company server rather than an online shopping mall server, and accordingly, the first payment reference data 400 received by the user terminal 1000 does not include information about the online shopping mall, but includes a PG company name as the payment reference data providing server information 401. In addition, purchased product information is not included in the first payment reference data 400. Accordingly, it may be difficult to determine which purchased product purchased from which online shopping mall matches the first payment reference data 400.

On the other hand, when a product is purchased from the offline store, payment is made through a VAN company, but an affiliated store name, not a VAN company name, may be displayed in the payment reference data providing server information 401 of the second payment reference data 410.

An application for providing purchase details and payment details may be installed in the user terminal 1000. For example, in response to receiving a trigger signal including the payment reference data 300 from the user terminal 1000, the application may record content included in the payment reference data 300. The user may identify the purchase details and the payment details through the application.

According to an embodiment, the application may analyze the pieces of payment reference data 400 and 410 to determine whether the pieces of payment reference data 400 and 410 relate to online payment. In detail, the application may store a name of the payment reference data providing server 2000 performing the online payment, and when the name matches a name in which the pieces of payment reference data providing server information 401 and 411 included in the pieces of payment reference data 400 and 410 are stored, determine that the pieces of payment reference data 400 and 410 relate to the online payment.

For example, when the PG company name is included in the first payment reference data 400, the application may determine that the first payment reference data 400 relates to the online payment. On the other hand, when the affiliated store name is included in the second payment reference data 410, the application may determine that the second payment reference data 410 relates to offline store payment.

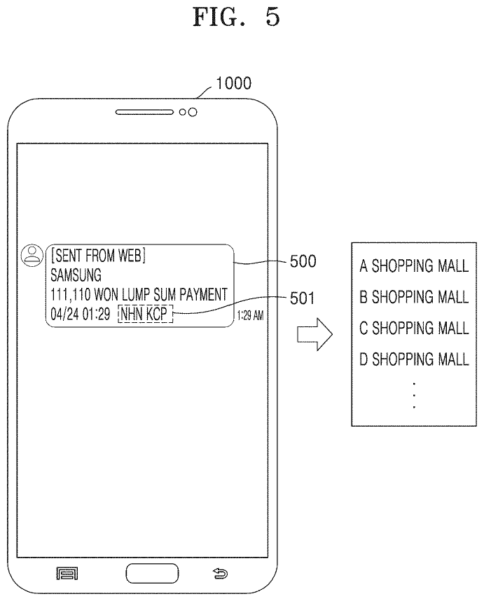

When the payment reference data relates to the online payment, the application may access the shopping mall server in response to the obtaining of the payment reference data. This will be described below with reference to FIG. 5.

Meanwhile, details described above as operations performed by an application may be operations performed by a server operating the application, and the same applies hereafter.

FIG. 5 is a diagram for describing an example of accessing a shopping mall server from an application, according to an embodiment.

The application may analyze payment reference data 500 to determine whether the payment reference data 500 relates to online payment. For example, when payment reference data providing server information 501 of the payment reference data 500 is a PG company name, the application may determine that the payment reference data 500 relates to the online payment.

After determining that the payment reference data 500 relates to the online payment, the application may access the online shopping mall server 3000 to which a user has provided access information. In order to access the online shopping mall server 3000, the application may receive the access information from the user for each online shopping mall server 3000. For example, the access information may include an identification (ID) and password (PW) of the user.

According to an embodiment, after determining that the payment reference data 500 relates to the online payment, the application may access all online shopping mall servers 3000 to which the user has provided the access information. For example, when the user has provided access information regarding an A shopping mall, a B shopping mall, a C shopping mall, and a D shopping mall, the application may access all four shopping mall servers.

According to another embodiment, after determining that the payment reference data 500 relates to the online payment, the application may analyze the payment reference data 500 and select a predetermined online shopping mall server 3000 from among a plurality of the online shopping mall servers 3000. Instead of accessing all the online shopping mall servers 3000, the application may access only the selected predetermined online shopping mall server 3000. PG companies used by the online shopping mall servers 3000 may be different from each other, or PG companies used by some online shopping malls may be the same. In detail, the application may select the predetermined online shopping mall server 3000 from among the plurality of online shopping mall servers 3000, by using a lookup table in which the online shopping mall server 3000 and a PG company for each online shopping mall server 3000 are matched. For example, when the A shopping mall and the B shopping mall from among the A, B, C, and D shopping malls use an “ABC” PG company, and a PG company name of the payment reference data 500 is “ABC”, an application is A may access only servers of the A shopping mall and B shopping mall.

According to another embodiment, after determining that the payment reference data 500 relates to the online payment, the application may request the user to specify an online shopping mall. In this case, the application may access only the online shopping mall server 3000 specified by the user. For example, when the user has selected the A shopping mall from among the A, B, C, and D shopping malls, the application may access only the server of the A shopping mall.

According to another embodiment, the application may train an artificial intelligence model by using matching data between the online shopping mall server 3000 and the PG company for each online shopping mall server 3000. Alternatively, the application may train the artificial intelligence model by using the payment reference data 500 and a result of the user selecting a shopping mall, the result corresponding to the payment reference data 500. Thereafter, the application may access the online shopping mall server 3000 corresponding to the payment reference data 500 by using the trained artificial intelligence model.

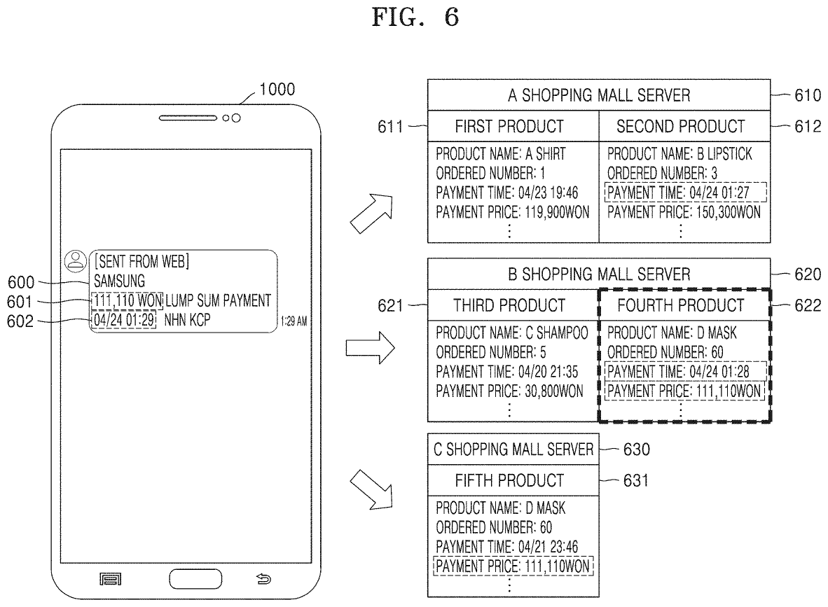

FIG. 6 is a diagram for describing an example of matching payment reference data and a purchased product, according to an embodiment.

An application may analyze payment reference data 600 to determine whether the payment reference data 600 relates to online payment. For example, when payment reference data providing server information of the payment reference data 600 is a PG company name, the application may determine that the payment reference data 600 relates to the online payment.

Also, after determining that the payment reference data 500 relates to the online payment, the application may access the online shopping mall server 3000 to which a user has provided access information.

Referring to FIG. 6, the application may access an A shopping mall server 610, a B shopping mall server 620, and a C shopping mall server 630. For example, when A, B, and C shopping malls use an “ABC” PG company, and a PG company name of the payment reference data 600 is “ABC”, the application may access the A shopping mall server 610, the B shopping mall server 620 and the C shopping mall server 630.

The application may access the plurality of online shopping mall servers 3000 to obtain purchased product information regarding a product purchased by the user. The application may obtain the purchased product information from the plurality of online shopping mall servers 3000 by using a data obtaining method, such as scraping, crawling, or the like, but the obtaining method is not limited thereto.

In detail, the application may compare price information 601 and time information 602 included in the payment reference data 600 with price information regarding at least one purchased product and time information about when the at least one purchased product is purchased, which are obtained from the plurality of online shopping mall servers 3000. Based on a result of the comparison, the application may select a purchased product matching the payment reference data 600 from among the at least one purchased product.

Referring to FIG. 6, the payment reference data 600 includes “111,110 won” as the price information 601 and “Apr. 24 01:29” as the time information 602.

The application may access the A shopping mall server 610 and obtain a payment time and a payment price regarding each of a first product 611 and a second product 612 purchased by the user. The payment time regarding the first product 611 is “Apr. 23 19:46” and the payment price thereof is “119,900 won”, and the payment time regarding the second product 612 is “Apr. 24 01:27” and the payment price thereof is “150,300 won”.

In the same manner, the application may access the B shopping mall server 620 and obtain a payment time and a payment price regarding each of a third product 621 and a fourth product 622 purchased by the user. Also, the application may access the C shopping mall server 630 and obtain a payment time and a payment price regarding a fifth product 631 purchased by the user.

The application may select a product with a payment price and a payment time respectively matching the price information 601 and the time information 602 included in the payment reference data 600. According to an embodiment, it may be determined that the price information 601 and the payment price match each other when they are the same, and the payment time and the time information 602 match each other when they are included within a predetermined time range, but an embodiment is not limited thereto.

Referring to FIG. 6, a payment time regarding the fourth product 622 of the B shopping mall server 620 is “Apr. 24 01:28” and a payment price thereof is “111,110 won”. The payment price is the same as the price information 601 “111,110 won” in the payment reference data 600, and the payment time is within an error range of “Apr. 24 01:29” that is the time information 602, and thus the application may select the fourth product 622 as a purchased product matching the payment reference data 600.

The application may obtain purchased product information regarding the fourth product 622 matching the payment reference data 600. In detail, the application may access the B shopping mall server 620 and obtain, as the purchased product information regarding the fourth product 622, information such as “Shopping mall information: B shopping mall”, “Product name: D mask”, “Ordered number: 60”, and the like.

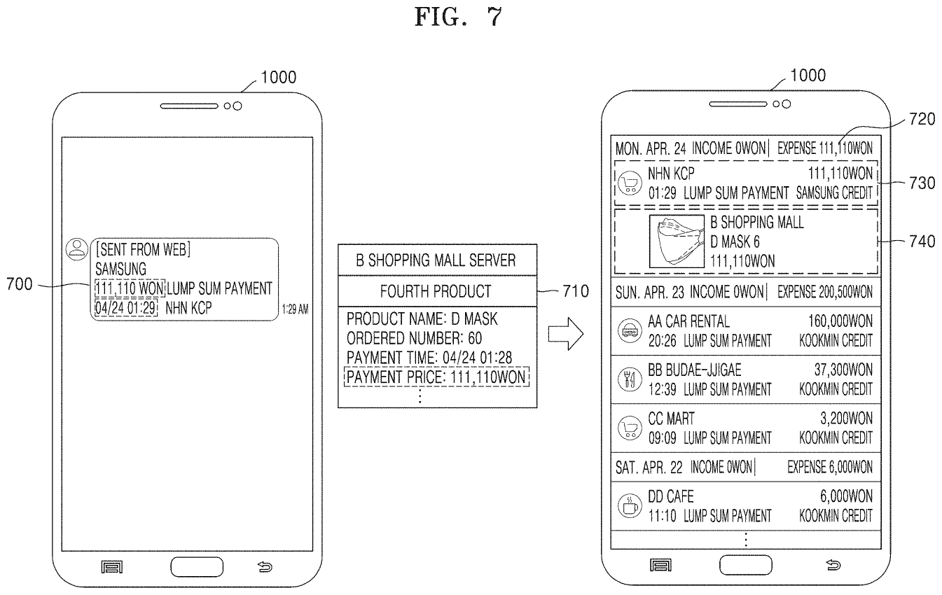

FIG. 7 is a diagram for describing an example of matching and displaying payment reference data and purchased product information, according to an embodiment.

In response to receiving, by the user terminal 1000, a trigger signal including payment reference data 700 from the payment reference data providing server 2000, an application 720 installed in the user terminal 1000 may record, as first information 730, content included in the payment reference data 700. When the payment reference data 700 includes payment-related information and payment reference data providing server information, the application 720 may record, as the first information 730, the payment-related information and payment reference data providing server information 351. Referring to FIG. 7, the application 720 may record, as the first information 730, content indicating that “the amount of 111,110 won has been paid in a lump sum by using Samsung Card at 01:29 on April 24”.

Also, the application 720 may analyze the payment reference data 700 and determine whether the payment reference data 700 relates to online payment. After determining that the payment reference data 600 relates to the online payment, the application 720 may determine at least one online shopping mall server 3000 to be accessed through various methods. The application 720 may access the at least one online shopping mall server 3000, compare purchased product information and the payment reference data 700, and select a purchased product matching the payment reference data 700. In detail, the application 720 may compare price information and time information included in the payment reference data 700 with price information regarding at least one purchased product and time information about when the at least one purchased product is purchased, which are obtained from the plurality of online shopping mall servers 3000. Based on a result of the comparison, the application 720 may select a purchased product matching the payment reference data 700 from among the at least one purchased product.

Referring to FIG. 7, the application 720 may select a fourth product 710 of a B shopping mall server as the purchased product matching the payment reference data 700, from among at least one product of the at least one online shopping mall server 3000, through the above-described processes.

The application 720 may access the B shopping mall server and obtain, as purchased product information regarding the fourth product 710, information such as “Shopping mall information: B shopping mall”, “Product name: D mask”, “Ordered number: 60”, and the like.

The application 720 may record, as second information 740, purchased product information regarding the purchased product selected to match the payment reference data 700. Referring to FIG. 7, the application 720 may match the first information 730 related to the payment reference data 700 with the second information 740 related to the fourth product 710, and provide the same to the user.

The payment reference data 700 does not include the purchased product information, such as shopping mall information, a product name, the quantity, and the like, and thus it may be difficult for the user to determine which purchased product matches the payment reference data 700 only with the content of the payment reference data 700.

In the method according to the present disclosure, the online shopping mall server may be accessed based on the payment reference data 700 and the purchased product information matching the payment reference data 700 may be obtained. In the method according to the present disclosure, the purchased product information matching the payment reference data 700 is provided to the user, together with the content included in the payment reference data 700, thereby helping the user to understand the payment reference data 700.

In the method according to the present disclosure, the purchased product information may be obtained from the online shopping mall server, based on the payment reference data 700, and the payment reference data 700 and the purchased product information may be matched and provided to the user. In other words, regardless of from which payment reference data providing server 2000 the payment reference data 700 is received (that is, regardless of a channel for obtaining the payment reference data 700), and regardless of how the payment reference data 700 is received, the method according to the present disclosure may improve user convenience by matching the payment reference data 700 and purchased product information via a unified method and providing the same to the user.

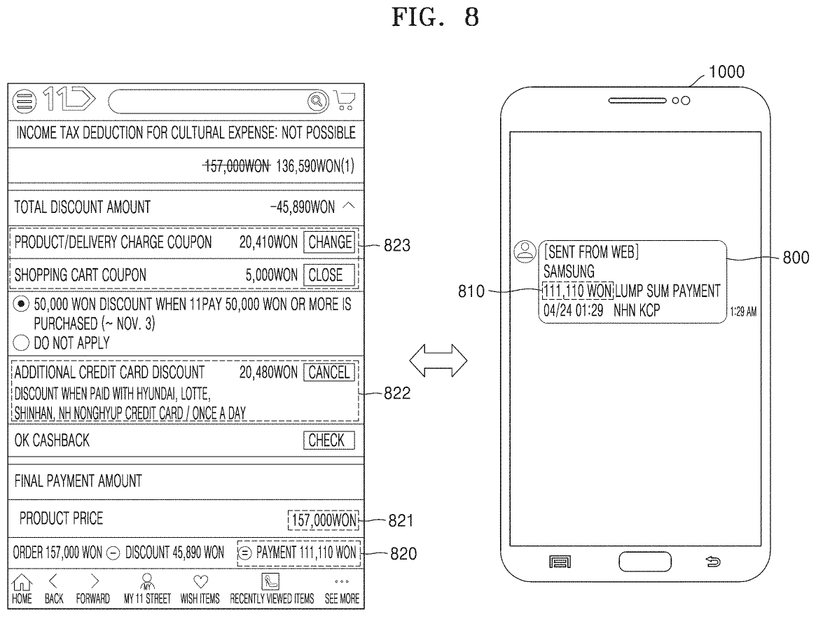

FIG. 8 is an exemplary diagram for describing a method of correcting price information regarding a purchased product, according to an embodiment.

Referring to FIG. 8, when a product is purchased from an online shopping mall, there may be a difference between an original selling amount 821 of a purchased product and a final payment amount 820. In detail, the final payment amount 820 of the purchased product may be determined by applying a shipping fee, a shopping mall discount 823, a credit card company discount 822, another discount, an exchange rate, and the like to the original selling amount 821.

According to an embodiment, price information 810 regarding the purchased product obtained from payment reference data 800 may match the final payment amount 820 of the purchased product. An application installed in the user terminal 1000 may match the payment reference data 800 with purchased product information by accessing an online shopping mall server and obtaining information about the final payment amount 820 of the purchased product.

According to another embodiment, the price information 810 regarding the purchased product obtained from the payment reference data 800 may be different from the final payment amount 820 of the purchased product. The application may access the online shopping mall server to obtain, in addition to the final payment amount 820, price correction information, such as the shipping fee, the shopping mall discount 823, the credit card company discount 822, the other discount, and the exchange rate. The application may obtain corrected price information by applying price correction to the final payment amount 820 by using the price correction information.

In detail, the application may determine whether the price information 810 of the payment reference data 800 is derived through a four fundamental arithmetic operation performed between the final payment amount 820 and the price correction information.

For example, the application may obtain the corrected price information through an operation of subtracting an amount of the credit card company discount 822 from the final payment amount 820, and compare the corrected price information with the price information 810 of the payment reference data 800. When the corrected price information and the price information 810 of the payment reference data 800 match each other, the application may determine that the corresponding purchased product matches the payment reference data 800.

Alternatively, currencies of the price information 810 of the payment reference data 800 and the final payment amount 820 may be different from each other. In this case, the application may convert the amount of the final payment amount 820 based on the currency of the price information 810. When the converted final payment amount 820 is included within a predetermined range of the price information 810, the application may determine that the purchase product matches the payment reference data 800. Alternatively, the application may convert the amount of the price information 810 based on the currency of the final payment amount 820.

Meanwhile, an exchange rate used when converting a specific currency to another currency may be an exchange rate of a date (for example, April 24) corresponding to time information of the payment reference data 800.

According to another embodiment, the price information 810 regarding the purchased product obtained from the payment reference data 800 may be different from the final payment amount 820 of the purchased product. In detail, the price information 810 of the payment reference data 800 may correspond to price total information regarding a plurality of products purchased from the online shopping mall.

The application may compare the price information 810 and time information included in the payment reference data 800 with price information regarding at least one purchased product and time information about when the at least one purchased product is purchased, which are obtained from the plurality of online shopping mall servers 3000. Based on a result of the comparison, the application may select a purchased product matching the payment reference data 800 from among the at least one purchased product.

According to an embodiment, when a purchased product matching the price information 810 of the payment reference data 800 is not identified from among the at least one purchased product, the application may select a plurality of purchased products by comparing the price information included in the payment reference data 800 with the price total information regarding the plurality of purchased products purchased for a predetermined period of time.

For example, the price information 810 of the payment reference data 800 may be 91,000 won, and prices of three purchased products purchased during the predetermined period of time may respectively be 27,000 won, 31,000 won, and 33,000 won. In this case, the price total information regarding the three purchased products is 91,000. The application may select the three purchased products and obtain purchased product information regarding the three purchased products from the online shopping mall server 3000.

The application may match the payment reference data 800 with the purchased product information regarding the three purchased products, and display a result of the matching.

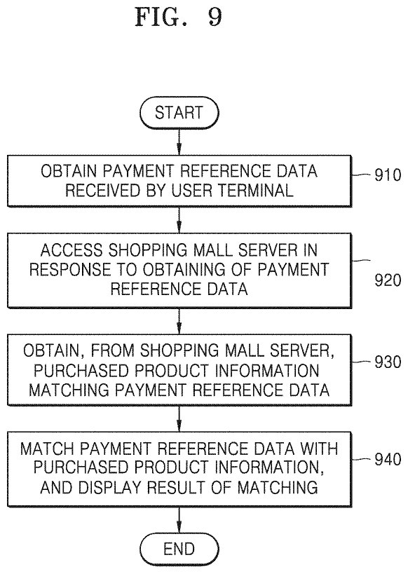

FIG. 9 is a flowchart of a method of matching and displaying payment reference data and purchased product information, according to an embodiment.

Referring to FIG. 9, in operation 910, a processor may obtain payment reference data received by a user terminal.

The user terminal may receive a trigger signal from a payment reference data providing server. The trigger signal may include a text message, a push notification, an email, or the like. The trigger signal may include the payment reference data. The user terminal may receive the payment reference data included in the trigger signal from the payment reference data providing server, and the processor may obtain the payment reference data in response to receiving the payment reference data from the user terminal.

The payment reference data may include payment-related information and payment reference data providing server information. The payment-related information may include at least one of price information, time information, and a payment method (for example, card payment, cash payment, or account transfer) related information regarding a purchased product. The payment reference data providing server information is information about a server that provides the payment reference data, and may include at least one of affiliated store information and PG company information.

According to an embodiment, the processor may obtain the payment reference data whenever the trigger signal including the payment reference data is received. According to another embodiment, the processor may set a predetermined time regardless of whether the trigger signal is received, and comprehensively obtain the payment reference data included in all trigger signals received for the predetermined time. According to another embodiment, in response to receiving an input of a user, the processor may comprehensively obtain the payment reference data included in all trigger signals received during a period of time between a previous user input and a current user input.

In operation 920, the processor may access a shopping mall server in response to the obtaining of the payment reference data.

The processor may analyze payment reference data and determine whether the payment reference data relates to online payment. When the payment reference data relates to the online payment, the processor may access the shopping mall server in response to the obtaining of the payment reference data.

According to an embodiment, after determining that the payment reference data relates to the online payment, the processor may access all online shopping mall servers to which the user has provided access information. According to another embodiment, after determining that the payment reference data relates to the online payment, the processor may analyze the payment reference data and select a predetermined online shopping mall server from among a plurality of online shopping mall servers. According to another embodiment, after determining that the payment reference data relates to the online payment, the processor may request the user to specify an online shopping mall. In this case, the processor may access only the online shopping mall server specified by the user.

In operation 930, the processor may obtain purchased product information matching the payment reference data from the shopping mall server.

The processor may compare price information and time information included in the payment reference data respectively with price information regarding at least one purchased product and time information about when the at least one purchased product is purchased, which are obtained from the shopping mall server. The processor may select a predetermined purchased product matching the payment reference data from among the at least one purchased product, based on a result of the comparison. The processor may obtain, from the shopping mall server, purchased product information regarding the predetermined purchased product.

The purchased product information may include shopping mall information, a product name, the quantity, manufacturer information, and the like.

The processor may obtain the purchased product information from the online shopping mall server by using a data obtaining method, such as scraping, crawling, or the like, but the obtaining method is not limited thereto.

In operation 940, the processor may match the payment reference data and purchased product information, and display a result of the matching.

The payment reference data does not include the purchased product information, such as shopping mall information, a product name, the quantity, and the like, and thus it may be difficult for the user to determine which purchased product matches the payment reference data only with content of the payment reference data. The processor may help the user to understand the payment reference data by providing the user with the purchased product information matching the payment reference data, together with the content included in the payment reference data.

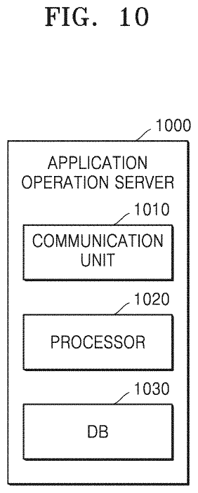

FIG. 10 is a block diagram of an application operation server according to an embodiment.

Referring to FIG. 10, an application operation server 1000 may include a communication unit 1010, a processor 1020, and a database (DB) 1030. Only components related to an embodiment are shown in the application operation server 1000 of FIG. 10. Accordingly, it may be understood by one of ordinary skill in the art that other general-purpose components may be further included in addition to the components shown in FIG. 10.

The communication unit 1010 may include one or more components for performing wired/wireless communication with user terminals and payment reference data providing servers. For example, the communication unit 1010 may include at least one of a short-range communication unit (not shown), a mobile communication unit (not shown), and a broadcast receiving unit (not shown).

The DB 1030 is hardware storing various types of data processed in the application operation server 1000, and may store a program for processes and controls by the processor 1020. The DB 1030 may store payment information, user information, and the like.

The DB 1030 may include random access memory (RAM) such as dynamic random access memory (DRAM) or static random access memory (SRAM), read-only memory (ROM), electrically erasable programmable read-only memory (EEPROM), CD-ROM, Blu-ray or another optical disk storage, a hard disk drive (HDD), a solid state drive (SSD), or a flash memory.

The processor 1020 controls all operations of the application operation server 1000. For example, the processor 1020 may generally control an input unit (not shown), a display (not shown), the communication unit 1010, the DB 1030, and the like by executing programs stored in the DB 1030. The processor 1020 may control operations of the application operation server 1000 by executing programs stored in the DB 1030.

The processor 1020 may control at least some of operations of an application described above with reference to FIGS. 1 to 9.

The processor 1020 may be realized by using at least one of an application specific integrated circuit (ASIC), a digital signal processor (DSP), a digital signal processing device (DSPD), a programmable logic device (PLD), a field programmable gate array (FPGA), a controller, a micro-controller, a microprocessor, and another electric unit for performing functions.

Various embodiments of the present disclosure may be implemented as software (for example, a program) including one or more instructions stored in a machine-readable storage medium. For example, a processor of the machine may invoke and execute at least one of the one or more instructions stored from the storage medium. Accordingly, the machine is enabled to operate to perform at least one function according to the at least one invoked instruction. The one or more instructions may include code generated by a compiler or code executable by an interpreter. The machine-readable storage medium may be provided in a form of a non-transitory storage medium. Here, ‘on-transitory’ only means that a storage medium is a tangible device and does not contain a signal (for example, electromagnetic waves). This term does not distinguish a case where data is stored in the storage medium semi-permanently and a case where the data is stored in the storage medium temporarily.

According to an embodiment, a method according to various embodiments of the present disclosure may be provided by being included in a computer program product. The computer program product is a product that can be traded between sellers and buyers. The computer program product may be distributed in a form of machine-readable storage medium (for example, a compact disc read-only memory (CD-ROM)), or distributed through an application store (for example, Play Store™) or directly or online between two user devices (for example, download or upload). In the case of online distribution, at least a part of the computer program product may be temporarily stored or temporarily generated in the machine-readable storage medium such as a server of a manufacturer, a server of an application store, or a memory of a relay server.

Furthermore, in the specification, the term “unit” may be a hardware component such as a processor or circuit and/or a software component that is executed by a hardware component such as a processor.

The scope of the present disclosure is defined by the appended claims rather than the detailed description, and all changes or modifications within the scope of the appended claims and their equivalents will be construed as being included in the scope of the present disclosure.

1. A method of matching and displaying payment reference data and purchased product information, the method comprising:
obtaining payment reference data received by a user terminal;
accessing a shopping mall server in response to the obtaining of the payment reference data;
obtaining purchased product information matching the payment reference data from the shopping mall server; and
matching the payment reference data and the purchased product information, and displaying a result of the matching.

2. The method of claim 1, wherein the obtaining of the payment reference data comprises:
receiving, by the user terminal, a trigger signal including the payment reference data; and
comprehensively obtaining the payment reference data included in the trigger signal received for a predetermined time, regardless of whether the trigger signal is received.

3. The method of claim 1, wherein the accessing of the shopping mall server comprises:
determining whether the payment reference data relates to online payment by analyzing the payment reference data; and
when the payment reference data relates to the online payment, accessing the shopping mall server in response to the obtaining of the payment reference data.

4. The method of claim 1, wherein the accessing of the shopping mall server comprises:
selecting a predetermined shopping mall server from among a plurality of shopping mall servers by analyzing the payment reference data; and
accessing the predetermined shopping mall server.

5. The method of claim 4, wherein the accessing of the shopping mall server comprises:
selecting the predetermined shopping mall server from among the plurality of shopping mall servers, based on a payment gateway (PG) name included in the payment reference data; and
accessing the predetermined shopping mall server.

6. The method of claim 1, wherein the obtaining of the purchased product information matching the payment reference data comprises:
comparing price information and time information included in the payment reference data respectively with price information regarding at least one purchased product and time information about when the at least one purchased product is purchased, which are obtained from the shopping mall server;
selecting a predetermined purchased product matching the payment reference data from among the at least one purchased product, based on a result of the comparing; and
obtaining, from the shopping mall server, purchased product information regarding the predetermined purchased product.

7. The method of claim 6, further comprising:
obtaining corrected price information by applying price correction to the price information regarding the at least one purchased product, obtained from the shopping mall server; and
comparing the price information included in the payment reference data with the corrected price information regarding the at least one purchased product.

8. The method of claim 6, wherein the selecting of the predetermined purchased product comprises, when the predetermined purchased product matching the payment reference data is not identified from the at least one purchased product as a result of the comparing, selecting a plurality of purchased products by comparing the price information included in the payment reference data with price total information regarding the plurality of purchased products purchased for a predetermined period of time,
wherein the predetermined period of time is determined by the time information included in the payment reference data.

9. A computer program product comprising one or more non-transitory computer-readable recording media storing a program for:
obtaining payment reference data received by a user terminal;
accessing a shopping mall server in response to the obtaining of the payment reference data;
obtaining purchased product information matching the payment reference data from the shopping mall server; and
matching the payment reference data with the purchased product information, and displaying a result of the matching.
